(19) United States
(12) Patent Application Publication
(10) Pub. No.: US 2024/0423414 A1
(43) Pub. Date: Dec. 26, 2024

(54) FRYER INCLUDING AUTOMATIC BASKET SHAKER LIFT AND VISION-BASED CONTROLS OF COOKING CYCLES AND COOKING MEDIUM SERVICING

(71) Applicant: Henny Penny Corporation, Eaton, OH (US)

(72) Inventors: Kimberly Reichelderfer, Yellow Springs, OH (US); Ares Marasligiller, Cincinnati, OH (US)

(21) Appl. No.: 18/748,713

(22) Filed: Jun. 20, 2024

Related U.S. Application Data
(60) Provisional application No. 63/509,477, filed on Jun. 21, 2023.

(51) Int. Cl. A47J 37/12; G06V 10/56; G06V 20/68

(52) U.S. Cl. CPC A47J 37/1266; A47J 37/1219; A47J 37/1223; A47J 37/1295; G06V 10/56; G06V 20/68

(57) ABSTRACT

An automated cooking system includes a fryer with at least one fryer vat configured to hold a cooking medium, and at least one basket configured to receive and hold a food product for cooking in the cooking medium at the fryer. The cooking system further includes a basket movement device including a basket support for engaging the at least one basket. The basket movement device is configured to move the at least one basket into and out of the cooking medium. Further, the basket movement device includes a retention clip to releasably secure the at least one basket to the basket support. The cooking system includes a vision system and a visual indicator system to help, with the basket movement device, automate workflow decisions and management at the fryer. A method of cooking food products and a method for managing basket workflow with/at an automated cooking system are also provided.

### CROSS-REFERENCE TO RELATED APPLICATIONS

This application claims the benefit of U.S. Provisional Application Ser. No. 63/509,477, filed Jun. 21, 2023, the disclosure of which is incorporated by reference herein.

### TECHNICAL FIELD

This application generally relates to food product cooking systems such as fryers. More specifically, this application describes automated systems and controls for use with fryers having at least one cooking vat for receiving a basket of food product.

### BACKGROUND

Cooking devices, such as fryers, are used to cook various food products, e.g., poultry, fish, potato products, and the like. Such cooking devices may include one or more cooking chambers, e.g., fryer pots or cooking vats, which may be filled with a cooking medium, e.g., an oil, a liquid shortening, or a meltable-solid shortening. Such cooking apparatus also may include a heating element, e.g., an electrical heating element, such as a heating coil, or a gas heating element, such as a gas burner and gas conveying tubes, which heats the cooking medium in the cooking chamber. After the cooking medium reaches a predetermined cooking temperature, the food products are placed into the cooking medium such that the food products are cooked in the cooking medium. For example, the food products may typically be positioned inside a basket, e.g., a wire basket, and submerged in the cooking medium for a predetermined amount of time sufficient to cook the food products.

Restaurants continually strive to increase production to satisfy customer demand. However, in many conventional kitchens, restaurant employees must complete or manage all the cooking and food preparation tasks to accomplish the increases in production and customer demand. For example, during a standard cooking cycle using a conventional open fryer with baskets for food products, an operator must fill the basket with frozen or fresh food product to be cooked; move the basket to an appropriate location (e.g., a cooking vat) within the fryer for cooking in the cooking medium; shake the basket at regular intervals to prevent certain food products from sticking or clumping together (also referred to as formation of product marriages) during frying; remove the basket from the fryer when a cooking cycle is completed; and transfer the cooked food products to a holding station or preparation station. It can become impossible for an operator to timely perform all these tasks associated with cooking cycles for a number of different cooking vats and a number of different food products if the expected production level or demand increases to a certain high level.

Restaurants also strive to provide the highest-quality cooked food product on a consistent basis. In the context of cooking food product with an open fryer, as described above, one significant factor for maintaining a consistent high quality of food product is regular filtration and level maintenance of the oil or other cooking medium used. Operators such as restaurant employees are also tasked with managing the cooking medium level and filtration cycles simultaneous with management of the various cooking cycles of food product noted above. The restaurant employee must monitor the level and color of the cooking medium to evaluate if the cooking medium in any of the cooking vats requires a filtration cycle, needs to be refilled (e.g., a top off), or needs to be changed, and this must often be done while cooking operations continue at other cooking vats in the fryer. It will be readily understood that this operator-based evaluation slows the cooking process because of the added demands placed on fryer operators, such as restaurant employees.

Furthermore, significant training is required for an operator to understand the appropriate times for all of these actions, both in cooking cycles for various food products and in filtration other and cooking medium maintenance cycles. To this end, the conventional fryer designs can necessitate operator intervention for each of product identification, filtration cycle starts, basket shaking and removal timing, cooking medium level verification, and more. With labor being a limiting constraint in present times for fields such as restaurant operations, such need for significant training and continual high demands on employees is generally undesirable. As a result, conventional fryers, operated manually in the traditional ways summarized above, cannot always achieve maximum product throughput or efficiency while maintaining consistent high quality cooked food product.

Therefore, it would be desirable to provide systems and methods for assisting an operator with the management of the various tasks associated with cooking cycles and cooking medium servicing (e.g., filtration cycles, refilling, changing out) at a fryer. Such systems and methods should help achieve the technical objectives of properly handling increased production demands in modern restaurant contexts, while also maintaining consistent high quality of cooked food product and limiting the labor-intensive nature of conventional fryer operations.

### SUMMARY

The embodiments of the present invention provide a fryer including an automatic basket shaker lift and vision-based controls of cooking cycles and cooking medium maintenance and methods of use thereof that address known drawbacks in the fryer art. Certain exemplary aspects of the invention are set forth below. It should be understood that these aspects are presented merely to provide the reader with a brief summary of certain forms the invention might take and that these aspects are not intended to limit the scope of the invention

In a first aspect of the invention, an automated cooking system is provided. The automated cooking system includes a fryer including at least one fryer vat configured to hold a cooking medium. The automated cooking system further includes at least one basket configured to receive and hold a food product for cooking in the cooking medium at the fryer. The automated cooking system also includes a basket movement device located proximate to the at least one fryer vat. The basket movement device includes a basket support for engaging the at least one basket. The basket movement device is configured to move the at least one basket into and out of the cooking medium. Further, the basket movement device includes a retention clip to releasably secure the at least one basket to the basket support.

In one embodiment, the retention clip may engage at least a portion of the basket. The retention clip may be biased to lock the at least one basket in position on the basket support thereby preventing the at least one basket from being inadvertently removed from the basket support. Further, the bias may be applied by a torsion spring of the basket support. The retention clip may be disengaged by contact with a cam catch surface. More specifically, contact with the cam catch surface may cause the retention clip to pivot against the bias such that the at least one basket may be removed from the basket support. In an alternative embodiment, the retention clip may be disengaged by a pneumatic cylinder. More specifically, the pneumatic cylinder may cause the retention clip to pivot against the bias such that the at least one basket may be removed from the basket support.

In another embodiment, the automated cooking system may further include a vision system. The vision system may include at least one camera and at least one image processor. The at least one camera may be mounted on a support. The support may be shared with the basket movement device. Further, the at least one camera may be configured to capture at least one visual image of the food product within the at least one basket. The at least one image processor may be configured to identify the food product from the at least one visual image. Furthermore, the at least one camera may be configured to capture at least one visual image of a color and/or a level of the cooking medium in the at least one fryer vat. The at least one image processor may be configured to identify a change in the color and/or the level of the cooking medium. Additionally, the automated cooking system may include a visual indicator system including at least one visual indicator configured to illuminate with different colors or different combinations of lights and/or colors to visually communicate information to an operator. The at least one series of lights may be mounted on the support shared with the basket movement device and shared with the at least one camera.

In a further embodiment, the automated cooking system may further include a visual indicator system. The visual indicator system may include at least one visual indicator to visually communicate information to an operator. The at least one visual indicator may be mounted on a support shared with the basket movement device. Further, the at least one visual indicator may illuminate in a color or in a combination/pattern to communicate that an associated fryer vat should next receive at the at least one basket. Additionally or alternatively, the at least one visual indicator may illuminate in a color or in a combination/pattern to communicate that the food product in the at least one basket of an associated fryer vat is fully cooked and that the at least one basket is ready to be removed from the fryer.

In another aspect of the invention, a method of cooking food products with an automated cooking system is provided. The method includes providing the automated cooking system. The automated cooking system includes a fryer including at least one fryer vat configured to hold a cooking medium. The automated cooking system further includes a basket movement device located proximate to the at least one fryer vat. The basket movement device includes a basket support. The method further includes attaching at least one basket of food product to the basket support. Additionally, the method includes releasably securing the at least one basket to the basket support with a retention clip. The retention clip is biased to lock the at least one basket in position on the basket support thereby preventing the at least one basket from being inadvertently removed from the basket support. The method further includes moving the at least one basket downwardly, by the basket movement device, to a lower position in which the at least one basket is substantially submerged in the cooking medium held within the at least one fryer vat, thereby beginning a cooking cycle for the food product. Additionally, the method includes moving the basket upwardly, by the basket movement device, to an upper position in which the at least one basket is located above the cooking medium in the at least one fryer vat, when the cooking cycle is completed.

In one embodiment, the retention clip may include a torsion spring and the step of releasably securing the at least one basket may further include applying a spring bias by the torsion spring to lock the at least one basket in position on the basket support. The method may further include disengaging the retention clip by contacting the retention clip with a cam catch surface to cause the retention clip to pivot against the spring bias of the torsion spring. In an alternative embodiment, the method may further include disengaging the retention clip using a pneumatic cylinder to cause the retention clip to pivot against the spring bias of the torsion spring.

In another embodiment, the automated cooking system may further include a vision system. The vision system may include at least one camera and at least one image processor. The method may further include capturing, by the at least one camera, at least one visual image of the food product within the at least one basket. Additionally, the method may include identifying, by the at least one image processor, the food product from the at least one visual image. Further, the method may include determining, by a fryer controller, the cooking cycle for the identified food product. Additionally, the method may include initiating, by the fryer controller, the cooking cycle. Furthermore, the method may include determining, by a fryer controller, that the identified food product requires shaking and then shaking, by the basket support, the at least one basket during the cooking cycle with rapid oscillation and/or vibration movements to break up any clumps or product marriages of the food product in the basket. The step of shaking may further include moving the basket upwardly during the cooking cycle prior to shaking, by the basket movement device, to an upper position in which the basket is located above the cooking medium in the fryer vat, thereby pausing the cooking cycle for the food product. The step of shaking may also include moving the at least one basket downwardly during the cooking cycle after shaking, by the basket movement device, to a lower position in which the at least one basket is substantially submerged in the cooking medium held within the fryer vat, thereby resuming the cooking cycle for the food product.

In a further embodiment, the automated cooking system may include a vision system. The vision system may include at least one camera and at least one image processor. The method may further include capturing, by the at least one camera, at least one visual image of a color of the cooking medium in the at least one fryer vat. The method may further include identifying, by the at least one image processor, a change in the color of the cooking medium from the at least one visual image. The method may further include determining, by a fryer controller, that the cooking medium requires filtration. The method may further include initiating, by the fryer controller, filtration of the cooking medium. Alternatively or additionally, the method may include capturing, by the at least one camera, at least one visual image of a level of the cooking medium in the at least one fryer vat. The method may further include identifying, by the at least one image processor, a change in the level of the cooking medium from the at least one visual image. The method may further include determining, by a fryer controller, that the cooking medium requires refilling. The method may further include initiating, by the fryer controller, refilling of the cooking medium. Alternatively or additionally, the method may include capturing, by the at least one camera, at least one visual image of a level of the cooking medium in the at least one fryer vat. The method may further include identifying, by the at least one image processor, a change in the level or a change in the color of the cooking medium from the at least one visual image. The method may further include determining, by a fryer controller, that the cooking medium requires replacement by changing out. The method may further include initiating, by the fryer controller, changing out of the cooking medium. Alternatively or additionally, the method may include capturing, by the at least one camera, at least one visual image of the at least one fryer vat. The method may further include identifying, by the at least one image processor, a status of the at least one fryer vat. The method may further include interpreting, by a fryer controller, the status of the at least one fryer vat. The method may further include communicating, by a visual indicator system, the status of the at least one fryer vat to an operator.

In yet another embodiment, the automated cooking system may further include a visual indicator system. The visual indicator system may include at least one visual indicator. The method may further include illuminating the at least one visual indicator in a color and/or in a combination/pattern to communicate information to an operator regarding cooking status or actions needed at one or more fryer vats. Alternatively or additionally, the method may include illuminating the at least one visual indicator in a color and/or in a combination/pattern to communicate to the operator that an associated fryer vat should next receive the at least one basket. Alternatively or additionally, the method may include illuminating the at least one visual indicator in in a color and/or in a combination/pattern to communicate to an operator that the food product in the at least one basket of an associated fryer vat is in the process of being cooked. Alternatively or additionally, the method may include illuminating the at least one visual indicator in a color and/or in a combination/pattern to communicate to an operator that the food product in the at least one basket of an associated fryer vat is fully cooked and that the at least one basket is ready to be removed from the fryer. Alternatively or additionally, the method may include illuminating the at least one visual indicator in a color and/or in a combination/pattern to communicate to an operator that an associated fryer vat is unavailable to be used.

In a further aspect of the invention, a method for managing basket workflow at an automated cooking system is provided. The automated cooking system includes a fryer including at least one fryer vat. The at least one fryer vat includes a basket movement device for receiving and moving a basket located proximate to the at least one fryer vat. The fryer also includes a vision system including at least one camera and at least one image processor and a visual indicator system including at least one visual indicator to visually communicate information to an operator. The method further includes illuminating the at least one visual indicator to communicate to the operator that the at least one fryer vat should receive the next basket. The method also includes placing the basket containing a food product on the basket movement device. The method also includes identifying, by the at least one camera and the at least one image processor, the food product in the basket and determining and initiating, by a fryer controller, the cooking cycle for the identified food product. The method also includes illuminating the at least one visual indicator to communicate to the operator that the food product in the basket is fully cooked and that the basket is ready to be removed from the fryer. The method also includes removing the basket containing fully cooked food product from the basket movement device.

It will be understood that various embodiments and aspects described above can be combined in any combination or sub-combination without departing from the scope of this disclosure.

### BRIEF DESCRIPTION OF THE DRAWINGS

Various additional features and advantages of the invention will become more apparent to those of ordinary skill in the art upon review of the following detailed description of one or more illustrative embodiments taken in conjunction with the accompanying drawings. The accompanying drawings, which are incorporated in and constitute a part of this specification, illustrate one or more embodiments of the invention and, together with the general description given above and the detailed description given below, serve to explain the one or more embodiments of the invention.

FIG. 1 is a perspective view of a fryer including an automatic basket movement device and further equipment enabling vision-based controls of cooking cycles and cooking medium maintenance, in accordance with an embodiment of the invention, with the movement device and further equipment shown only at one cooking vat of the fryer for illustration clarity.

FIG. 2 is a side cross-sectional view taken through a midpoint of a basket and the automatic basket movement device of FIG. 1, showing a retention clip of the movement device engaged with the basket.

FIG. 3 is a side cross-sectional view similar to FIG. 2, showing movement of the basket and a cam-actuated disengagement of the retention clip from the basket.

FIG. 4 is a front (partially cross-sectioned) view of a fryer including automatic basket movement devices and further equipment enabling vision-based controls of cooking cycles and cooking medium maintenance added to each cooking vat of the fryer and multiple baskets in use at the fryer, in accordance with an embodiment of the invention, showing various stages of a cooking cycle.

FIG. 5 is a flowchart showing several operational steps performed by a fryer in accordance with embodiments of the invention.

### DETAILED DESCRIPTION

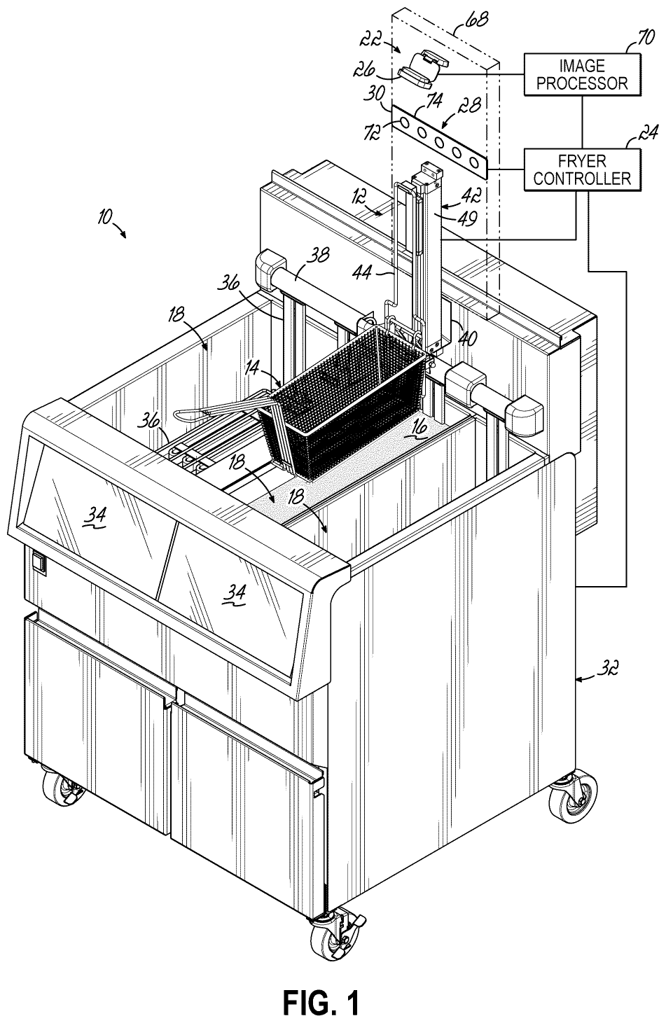

With reference to FIGS. 1 through 4, a fryer 10 is shown in accordance with one embodiment of the present invention. The fryer 10 generally includes at least one automatic basket movement device 12 and further equipment that allows for enhanced vision-based controls of several operations during cooking cycles and maintenance at the fryer 10. As set forth in further detail below, the automatic basket movement device 12 is configured to move a basket 14 into and out of cooking medium 16 contained within a cooking vat 18 or other similar chamber for receiving basket 14. The automatic basket movement device 12 also advantageously operates to move a basket 14 in a vibratory or shaking manner at certain intervals within a cooking cycle for food products 20 held in the fryer 10 by the basket 14. These movements of the basket 14 with the automatic basket movement device 12 are properly timed and tailored for the specific food product 20 being cooked in the basket 14, and this functionality is enabled by the vision-based controls operated by the fryer 10.

To this end, the further equipment noted above may include a vision system 22 that communicates with a fryer controller 24 to provide various inputs for actuating the components of the fryer 10 and the basket movement device 12. For example, the vision system 22 may include a camera 26 that can capture a visual image of the food product 20 in the basket 14 such that the specific cooking cycle parameters such as the cooking medium 16 temperature and/or cooking/shake times can be implemented for the correct food product 20 by the fryer 10 and the basket movement device 12. Moreover, the camera 26 can also capture a visual image of the cooking medium 16 to provide input for the controller 24 to initiate a maintenance operation-such as a filtration cycle, refilling, or a wholesale change out (also referred to as replacement herein) of the cooking medium 16 when necessary.

The further equipment may also include a visual indicator system 28 that visually provides workflow updates to a fryer 10 operator, such as a restaurant employee. For example, the visual indicator system 28 may include one or more visual indicators 30 that can visually communicate to a fryer 10 operator the status of a cooking vat 18 or food product 20 within a basket 14 at the fryer 10. This allows for the particular cooking cycle for a food product 20 to be closely adhered to or for workflow at the fryer 10 to be better managed, for example.

Consequently, the need for a fryer 10 operator, such as a restaurant employee, to fully manage such decisions and operational steps is eliminated, which frees up more time for the operator to perform other functions within the restaurant or kitchen. As a result, the fryer 10 according to these and other embodiments of the invention allows for increased production and demands to be handled with less labor needed, while also assuring more consistency in delivering high-quality food product 20 from the fryer 10 as well. The features of the fryer 10, the automatic basket movement device 12, the vision system 22, and the visual indicator system 28 are set forth in further detail below to clarify each of these functional advantages and other benefits provided in this disclosure.

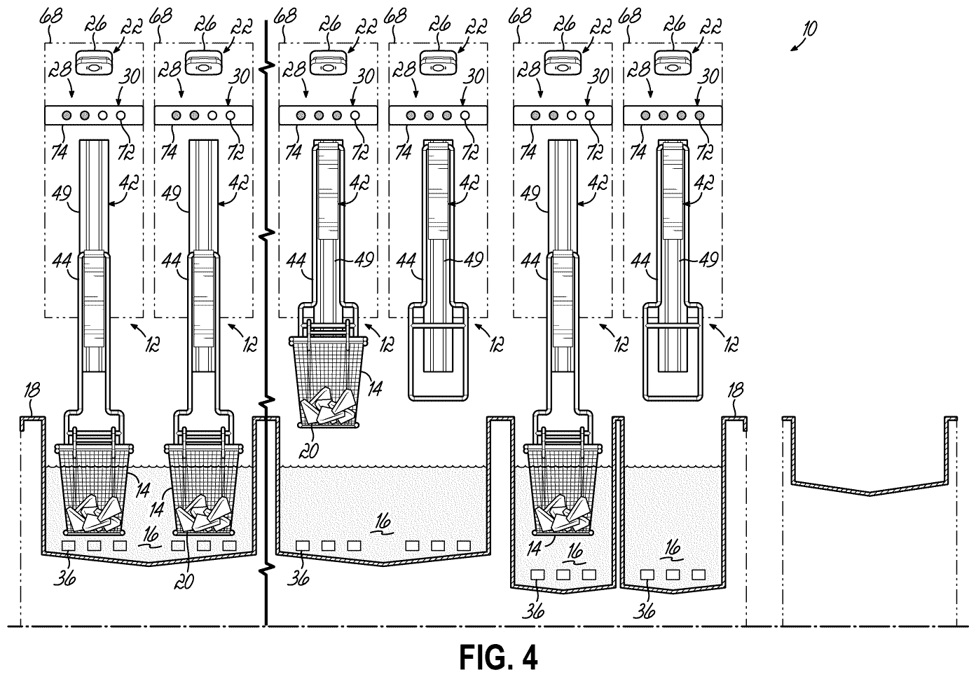

With reference to FIG. 1 (and FIG. 4, described later), a fryer 10 in accordance with one embodiment of this invention is shown to include a plurality of cooking vats 18 along the length of a framework thereof. The fryer 10 may be just a portion of a larger fryer subsystem, but only a portion of such a subsystem is shown in FIG. 1 for better illustration clarity. The cooking medium 16 is shown in one of the vats 18 for clarity. The vats 18 are supported by the fryer housing 32 in this embodiment, the housing 32 enclosing a space beneath the vats 18 for control and recirculation/filtration equipment such as drain pan(s) and pump(s), as will be readily understood in the field of fryers. The fryer 10 illustrated in FIG. 1 also includes a user interface 34 along a front side of the housing 32, but it will be understood that additional interface elements (e.g., the vision system 22 and the visual indicator system 28) have been added to enhance communications to human operators as set forth in further detail below. The user interface 34 may include one or more touchscreens. The specific elements of the exemplary fryer 10 shown in FIG. 1 are not described in further detail herein, as the focus is on the newly-added elements which can be retrofitted and added to almost any known fryer design. However, a couple commercially-available designs of such fryers and their further details can be reviewed at the “F5™ Series” of fryers and at the “Evolution Elite®” series of fryers from Henny Penny Corporation, of Eaton, Ohio.

Each of the cooking vats 18 in this embodiment includes a heating element 36, one of which is shown on the left of FIG. 1. The heating element 36 extends downwardly into the vat 18, so as to be submerged in cooking medium 16. In the depicted embodiment, the heating element 36 is an electric heating element. In an alternative embodiment, the heating element 36 could be a gas powered heating element-typically located outside the cooking vat 18- or another kind of heating element. Some of the vats 18 may be sized to receive multiple baskets 14 of food product 20 (as exemplified by the leftmost cooking vat 18 in FIG. 1), while others may be sized to receive a single basket 14 (as exemplified by the two rightmost cooking vats 18 in FIG. 1). It will be understood that variations from the particular vat layout in the fryer 10 may be made in other embodiments without departing from the scope of the present invention. Likewise, while all the vats 18 are shown as conventional open fryer vats 18 in this embodiment, it will be understood that modifications such as inclusion of one or more pressure fryer vats in this regard are also possible within the scope of the invention, and furthermore, different types and combinations of heating elements may be used in other embodiments. To this end, the movement device 12 and the further equipment for vision-based controls (e.g., vision system 22 and visual indicator system 28) can be implemented using many different types of fryers 10, and the fryers 10 shown in these Figures are merely examples of such.

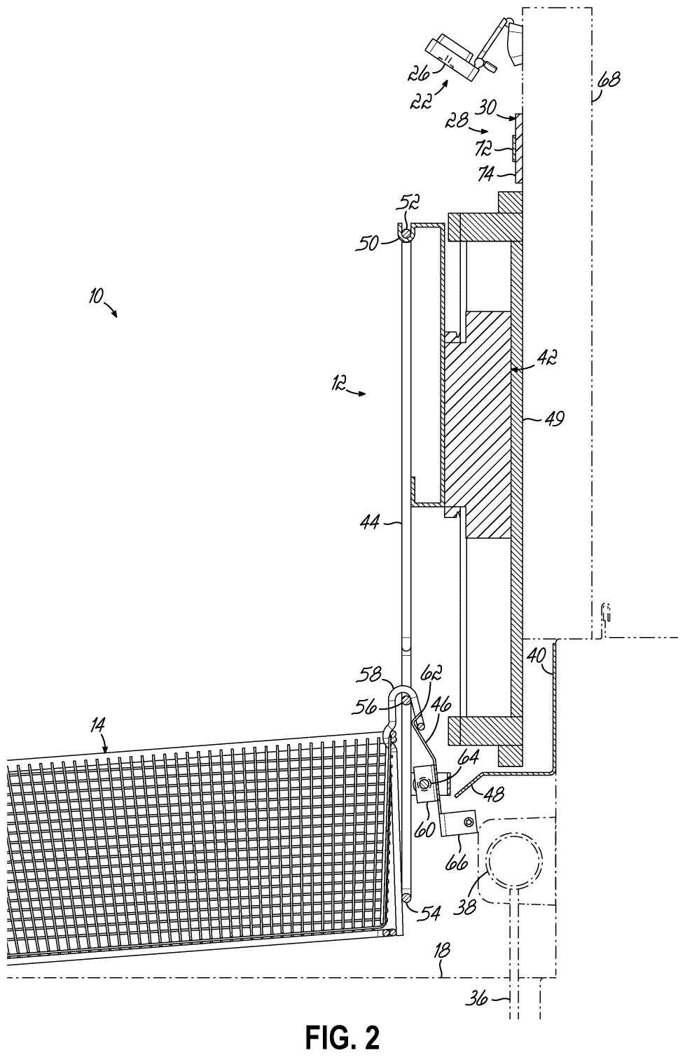

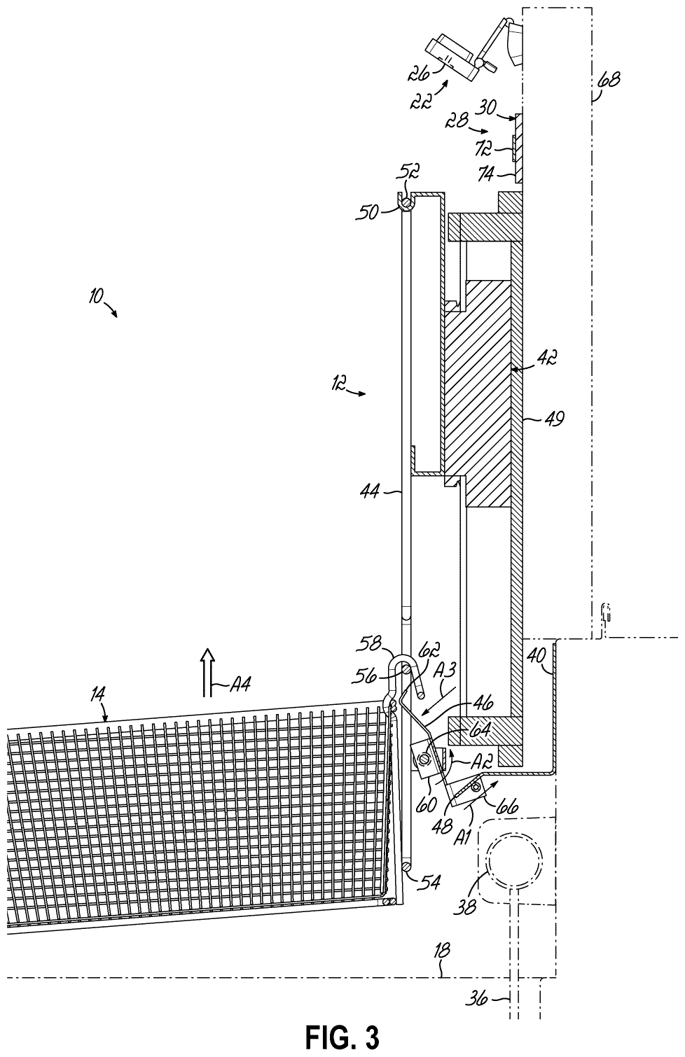

Referring now to FIGS. 2 and 3, the automatic basket shaker lift defined by the movement device 12 is shown in further detail. The movement device 12 is configured to transport the basket 14 upwardly and downwardly relative to the cooking vat 18, and thereby automatically control all basket 14 movements during cooking cycles at the fryer 10. In the depicted embodiment, the movement device 12 is mounted to a rear wall of fryer housing 32 that extends behind and above the back of each cooking vat 18, e.g., the wall where the top end of the support mounts 38 for heating elements 36 are typically mounted. It should be understood that the movement device 12 could, alternatively, be mounted to a different portion of the fryer housing 32. For example, the movement device 12 could be mounted to the framework of the fryer 10. As such, the movement device 12 is configured for retrofitting/adding onto many existing types of open fryers. One of the movement devices 12 now described can be added at each cooking vat 18 or each area where a basket 14 would normally enter a cooking vat 18-though it is not necessary for each cooking vat 18 to include a movement device 12. For example, one or more cooking vats 18 may be reserved for wholly manual operation by an operator.

The movement device 12 of this embodiment more generally includes a support bracket 40, a drive mechanism 42, a basket support 44, and a retention clip 46. In the depicted embodiment, the support bracket 40 is generally L-shaped and is mounted in a stationary manner on the fryer 10. It should be understood that the support bracket 40 may take on other forms. The support bracket 40 may be mounted on the rear end of the fryer 10 just above the support mount(s) 38 of the heating elements 36. It should be understood that the support bracket 40 may be mounted to a different portion of the fryer 10. A free end of the support bracket 40 (i.e., the end of the support bracket 40 not mounted to the fryer 10) extends outwardly from the fryer 10 (e.g., in the direction of the vat 18) and angles downwardly in the direction of the basket support 44 to define a cam catch surface 48, the function of which is described further below. The drive mechanism 42 includes a housing 49, as shown in FIGS. 1-4, that may sit on a portion of the support bracket 40. The drive mechanism 42 internal elements are not shown in detail in the figures, but typical drive mechanism 42 internal elements may include electric or rodless pneumatic drives configured to generate a linear movement upwardly and downwardly of the basket support 44 connected to a front of the drive mechanism 42, as would be understood by one of ordinary skill in the art.

With continued reference to FIGS. 2 and 3, the basket support 44, in the depicted embodiment, is defined by a loop-shaped elongate rod member that extends between an upper end 52 (in the form of a support crossbar) and a lower end 54. It should be understood that the basket support 44 may take on other forms. The upper end 52 of the basket support 44 engages with a mounting hook 50 extending from a front of the drive mechanism 42. The lower end 54 of the basket support 44 is configured to engage with the basket 14. More particularly, the lower end 54 of basket support 44 in this embodiment includes a support crossbar 56 and a clamp mounting bracket 60. The support crossbar 56 is configured to receive hanger hook(s) 58 located at the back end of the basket 14. It should be understood that, in alternative embodiments, the basket 14 may interface with the basket support 44 in a different way. In the depicted embodiment, the clamp mounting bracket 60 is connected to a rear-facing (i.e., fryer facing) side of the basket support 44-opposite where the basket 14 is located when mounted on the basket support 44, as shown in these views. The retention clip 46 is pivotally mounted on the clamp mounting bracket 60 so as to be positioned behind the basket support 44 (i.e., between the basket support 44 and the support bracket 40). It is to be understood that the retention clip 46 could be alternatively located and/or alternatively connected to the basket support 44.

A first operational position of the movement device 12 is shown in FIG. 2, this operational position being an initial position where the basket 14 is locked in engagement with the basket support 44 by the retention clip 46. In this position, an upper end 62 of the retention clip 46 is pivoted into engagement with an opening in the hanger hook(s) 58 on the rear end of basket 14. A spring bias applied by a torsion spring 64, for example, at the clamp mounting bracket 60 biases the retention clip 46 to this engaged position. With the retention clip 46 in the engaged position, the hanger hook 58 is prevented from moving upwardly past the upper end 62 of the retention clip 46. Thus, the retention clip 46, when engaged, prevents the hanger hook 58 from upward movement that would disengage the basket 14 from the support crossbar 56 at the basket support 44. In this regard, the retention clip 46 locks the basket 14 in position on the basket support 44 to prevent accidental/unintended removal of the basket 14 during a cooking cycle. It is to be understood that the retention clip 46 could be biased into engagement with the hanger hook(s) 58 in an alternative way. The first operational position is a top position at which the basket 14 is held during a cooking operation at the fryer 10 (but as will be described above, further upward movements are possible to unlock the basket 14 after a cooking operation is completed).

From this first operational position in FIG. 2, the drive mechanism 42 can move the basket support 44 and the basket 14 vertically downward and then upward without worry of the basket 14 disengaging from the support bracket 40. For example, after the basket 14 is initially placed and locked in position as described, the fryer controller 24 can initiate a cooking cycle when the cooking medium 16 is at the correct cooking temperature by actuating the drive mechanism 42 to move the basket support 44 downward such that the basket 14 filled with food product 20 is submersed in the cooking medium 16. At specific time intervals during the cooking cycle, it may be desired to shake the basket 14 to break up any product marriages that may have formed during cooking. The basket 14 may be shaken by the drive mechanism 42 one or more times during the cooking cycle as necessary to prevent food product marriages and to ensure a high-quality cooked food product 20.

In such a situation, the fryer controller 24 may actuate the drive mechanism 42 to rapidly oscillate the basket support 44 upward and downward to perform this shaking. In one example, the small upward and downward movements may extend through about 0.2 inches of total movement and may cycle up-and-down once per second. The shaking movement may apply approximately 5 g's of force when accelerating the basket 14 in the upward and downward movements. The intensity of the shaking may vary depending on the specific food product 20. The shaking movement may be performed while the basket 14 is submerged in the cooking medium 16 or, alternatively, the basket 14 may be lifted from the cooking medium 16 prior to performing the shaking movement and subsequently returned to the cooking medium 16 after the shaking movement is performed. Alternatively or additionally, the shaking movement may be performed in a horizontal direction as opposed to a vertical direction. How frequently (if at all) the food product 20 is shaken during the cooking cycle may depend on the specific food product 20.

With continued reference to FIG. 2, once a cooking cycle is completed, the fryer controller 24 actuates the drive mechanism 42 to move the basket support 44 back towards the first operational position. This removes the basket 14 from submersion in the cooking medium 16 and allows excess cooking medium 16 (e.g., oil) to drip off back into the cooking vat 18. All of these steps are automated by use of the fryer controller 24 and the movement device 12. It will be understood that the retention clip 46 prevents the basket 14 from inadvertently falling off the basket support 44 during the rapid shaking movements or before the cooking cycle is properly completed. Such functions keep a human operator from needing to manage these particular steps of a cooking cycle, while assuring improved and consistent cook quality for each cooking cycle.

If the drive mechanism 42 moves the basket support 44 further upwardly from the first operational position, the basket support 44 moves to a second operational position shown in FIG. 3. As a result of this small amount of upward movement, a lower end 66 of the retention clip 46 is brought into engagement with an underside of the cam catch surface 48 on the free end of the support bracket 40. This engagement coupled with continued upward movement of the basket support 44 (and the retention clip 46, which is mounted on the clamp mounting bracket 60 carried by basket support 44) forces a cam-like action of the lower end 66 of the retention clip 46 (as shown by movement arrow A1 in FIG. 3). The cam-like action of the lower end 66 of the retention clip 46 forces a pivotal movement of the retention clip 46 (as shown by movement arrow A2 in FIG. 3) against the spring bias of the torsion spring 64 to thereby move the retention clip 46 to the position shown in FIG. 3 (i.e., disengaged from the hanger hooks(s) 58 of the basket 14). It should be understood that alternative mechanisms may be used to disengage the retention clip 46. For example, in an alternative embodiment, the retention clip 46 may be released by a pneumatic cylinder to thereby move to an unlocked state.

In this second operational position of the movement device 12, the upper end 62 of the retention clip 46 has pivoted away from engagement with the opening in the hanger hook(s) 58 (as shown by movement arrow A3 in FIG. 3). This releases the lock that previously prevented upward movement and removal of the basket 14 (as shown by movement arrow A4 in FIG. 3) from the support crossbar 56 of the basket support 44. As readily understood in FIG. 3, this second operational position is an uppermost extent of the vertical movement caused by the movement device 12. When the movement device 12 is in the second operational position (and thus the retention clip 46 is disengaged), the basket 14 is free to be removed and replaced by a human operator or by a robotic basket movement system. However, the basket 14 does not automatically fall off or disengage when the retention clip 46 is unlocked. The total movement between the first and second operational positions shown in FIGS. 2 and 3 may be about one inch, whereas the total translation movement of the basket support 44 between FIG. 3 and the fully submerged position (as shown in FIG. 4) may be 10 inches or more. It should be understood that these movement values may vary depending on the particular fryer the movement device 12 is attached to.

With reference to FIGS. 2 and 3, it will be understood that the retention clip 46 of the movement device 12 defines a roller latch or cam latch type of mechanism for locking the basket 14 into engagement with the basket support 44. Though, it should be understood that alternative mechanisms may be used. For example, in an alternative embodiment, the retention clip 46 may be released by a pneumatic cylinder. It can also be seen clearly in FIGS. 2 and 3 that the various movements of the basket support 44 do not interfere with the preexisting structure of the fryer 10 such as the heating elements 36 of the fryer 10, which allows for retrofitting of the movement device 12 onto fryers of varying designs. The drive mechanism 42 and basket support 44 shape and specifics may be modified in further embodiments, and it will be understood that operational parameters such as total translation length vertically and the amplitude and frequency of the shaking vibrational movements are adjustable to meet the needs of different fryers, end users, and use cases.

As initially described above, the fryer 10 of the embodiments of this invention is further improved by adding further equipment to enable vision-based controls of various fryer operations-such as cooking medium 16 maintenance operations. To that end, an embodiment of the fryer 10 includes a vision system 22. The vision system 22 includes at least one camera 26 or other similar imaging device and, typically, at least one camera 26 at each of the cooking locations defined at the cooking vats 18 as shown in FIG. 4, for example. One such camera 26 is also schematically shown in FIGS. 1-3. Generally, the camera(s) 26 are directed downwardly towards the cooking vat 18 and the basket 14 when present at the cooking vat 18. Thus, each camera 26 captures visual images of any food product 20 contained within the basket 14 that the camera 26 is aimed towards. Additionally, each camera 26 can also detect a color and height/level of the cooking medium 16 within the cooking vat 18. The camera(s) 26 may be mounted on the same support 68 as the drive mechanism 42 of the movement device 12, for example. In some embodiments, the support 68 may be the housing 49 of the drive mechanism 42. That is to say that the camera 26 could be mounted to the housing 49 of the drive mechanism 42. The shared support 68 further facilitates retrofitting an existing fryer with the movement device 12 and vision system 22. It should be understood that one camera 26 could be used monitor more than one cooking vat 18. In other words, it is not necessary for each cooking vat 18 to have a dedicated camera 26 for monitoring. One camera 26 could monitor one more cooking vats 18 at the fryer 10.

The one or more cameras 26 are connected operationally to an image processor 70. The image processor 70 may be integrated software algorithms or programming loaded on a microprocessor as well understood in the fields of digital imaging and controls. Although shown as a separate block element in FIG. 1, for example, the image processor 70 may be integrated with the fryer controller 24 in some embodiments. The camera 26 provides input in the form of still images or continuous video that can be processed by the image processor 70 into detected statuses to determine appropriate control inputs that help the fryer controller 24 determine what actions to automatically perform in accordance with the invention.

With continued reference to FIG. 4, for example, the camera 26 and image processor 70 (e.g., microcontroller) equipment combination can detect when food product 20 is placed in a basket 14 at the fryer 10, and furthermore, can identify specifically what type of food product 20 is in the basket 14. The fryer controller 24 may be programmed with different series of time periods for starting and ending cooking (e.g., the cooking cycle) and for shaking food product 20 during the cooking cycle depending on the type of food product 20. Typically, the selection of the food product 20 has to be entered manually by an operator at the user interface 34 to allow for any automation or automated notification signals to be provided for such actions of the cooking cycle. But, the vision-based controls provided by the equipment-specifically, the vision system 22-in this embodiment fully automates that food product 20 determination process and associated input to the fryer controller 24. When combined with the movement device 12 described herein, the fryer controller 24 can start and complete an appropriate cooking cycle for any known food product 20 that is detected by the camera 26 and image processor 70 by actuating appropriate operations of the movement device 12 accordingly. Overcooking or undercooking of the food product 20 is therefore avoided, and the consistent timing and execution of shaking movements assures that each cooking cycle generates high quality food product 20 with minimal operator intervention.

The additional equipment of the vision system 22 also allows for automated prompting and operation of filtration cycles for, refilling of, and/or replacement of the cooking medium 16. To this end, the camera 26 and image processor 70 equipment combination can detect when a cooking medium 16 (e.g., oil) level in the cooking vat 18 is too low, or a coloration of the cooking medium 16 has changed sufficiently to indicate that filtration, refilling, and/or replacement is desired to maintain a high quality of future cooked food product 20. These inputs are provided as signals to the fryer controller 24, and appropriate remediation actions are then taken. For the cooking medium 16 level being too low, the pumps of the fryer 10 can be actuated by the fryer controller 24 to refill (e.g., top off) the cooking medium 16 by adding an additional amount of new cooking medium 16 into the cooking vat 18. For discoloration of the cooking medium 16 indicating that filtration or changing out of the cooking medium 16 is needed, the recirculation and filtration system within the fryer 10 can be actuated by the fryer controller 24 at a convenient time (e.g., between cooking cycles or when the cooked food product 20 is not in high demand) at the cooking vat 18 to remove and replace the cooking medium 16 after filtration thereof.

With continued reference to FIG. 4, as the camera 26 and image processor 70 are capable of detecting cooking medium 16 level changes and cooking medium 16 color changes to a more precise degree than most human operators, the decisions of when to refill, filter, or replace the cooking medium 16 are made more reliably at the time when such operations are needed, thereby better assuring a better cooking medium 16 quality over time and a consistent high quality cook of food products 20 at the fryer 10. Thus, the vision system 22 of the fryer 10 of the embodiments of this invention improves consistency and quality while minimizing human or robot operator interaction and inputs needed, with this automation allowing for higher quantities of food product 20 to be reliably cooked at high quality to meet the increasing demands in industries such as restaurants.

The added vision-based equipment for the fryer 10 of this invention may also include a visual indicator system 28 for providing feedback on aspects of the operational status of the fryer 10. The visual indicator system 28 includes at least one visual indicator 30 and typically at least one visual indicator 30 at each of the cooking locations defined at the cooking vats 18 as shown in FIG. 4, for example. Generally, the visual indicator(s) 30 are located roughly at operator eye height above the cooking vats 18. The visual indicator(s) 30 may be mounted on the same support 68 as the drive mechanism 42 of the movement device 12, for example, as shown in FIGS. 1-4. The same support 68 may also be shared by a camera 26 of the vision system 22. As previously mentioned, in some embodiments the shared support 68 may be the housing 49 of the drive mechanism 42. This shared support 68 further facilitates retrofitting an existing fryer with the movement device 12 and vision system 22.

With continued reference to FIG. 4, in one embodiment, the visual indicator 30 may be a series or row of LED lights 72 affixed to or located within a housing 74. It is to be understood that the visual indicator 30 could take on other forms. The housing 74 may be mounted on the same support 68 as the camera 26 and as the drive mechanism 42 of the movement device 12, for example. As shown in the drawings, the visual indicators 30 are conveniently located on the movement device 12 to keep the visual indicator 30 and the operator focus at the same location as where actions in the basket 14 workflow will then need to be taken at the cooking vat 18 of fryer 10. The LED lights 72 of the visual indicator 30 may be configured to illuminate with different colors or different combinations or patterns of lights to provide information on operational states to the operator of the fryer 10. Specifically, the LED lights 72 are operatively connected to the fryer controller 24 to receive signals that determine how to illuminate, which again is dependent on the current operational state of the cooking vat 18 (and/or the movement device 12) associated with the particular visual indicator 30.

In embodiments where the baskets 14 are manually moved by a human operator to and from the cooking vats 18 of fryer 10, the visual indicator(s) 30 of the visual indicator system 28 may illuminate in different colors or patterns to communicate which cooking vat 18 and associated movement device 12 should be the next one to receive a basket 14 containing food product 20 to be cooked. For example, the a visual indicator 30 may illuminate in a first color, combination, or pattern to communicate to an operator of the fryer 10 that the cooking vat 18 associated with the visual indicator 30 is ready to (or should) receive a basket 14 of food product 20. Thus, with a quick glance at all of the visual indicators 30, an operator is instructed where to put incoming basket(s) 14 of food product 20 and the operator does not have to manage this workflow processing mentally on their own.

With continued reference to FIG. 4, similarly, the illumination of the visual indicator(s) 30 may change when a basket 14 is ready with cooked food product 20 to be removed from the fryer 10. For example, a visual indicator 30 may illuminate in a second color, combination, or pattern to communicate to an operator of the fryer 10 that the food product 20 is fully cooked and the basket 14 is ready to be removed from the fryer 10. This avoids having the human operator try to remove baskets 14 before a cooking cycle is totally completed, which may include the drip time after the cooking (e.g., the visual indicator 30 does not change to indicate completion of the cooking cycle until the movement device 12 actually moves to the unlocked configuration shown in FIG. 3 and described above).

Further, the visual indicator(s) 30 may be utilized to convey to an operator that a cooking vat 18 is unavailable for a new basket 14 of food product 20. For example, a visual indicator 30 may illuminate in a third color, combination, or pattern to communicate to an operator of the fryer 10 that the cooking vat 18 associated with the visual indicator 30 is currently in use (e.g., a basket 14 of food product 20 is actively submerged in the cooking vat 18). Additionally, a visual indicator 30 may illuminate in a fourth color, combination, or pattern to communicate to an operator of the fryer 10 that the cooking vat 18 associated with the visual indicator 30 is undergoing maintenance. Such may occur if the cooking medium 16 in the cooking vat 18 is being filtered, refilled, or changed out, for example—which may be initiated by the vision system 22 and/or the fryer controller 24.

With continued reference to FIG. 4, the visual indicator system 28, based on instructions from the fryer controller 24, therefore illuminates the visual indicator(s) 30 to, among other things, balance cooking workload at each of the cooking vats 18 while also allowing for a cooking vat 18 to be skipped when a filtration cycle, refilling, or replacement is needed or actively underway (including a recovery heating time after a filtration cycle). Thus, the visual indicators 30 provided by the LED lights 72, for example, help achieve workload balancing of the cooking vats 18 simultaneous to work flow management and/or the providing of instructions to an operator for most efficient work flow- and it will be understood that further functions can be assisted by use of the visual indicators 30 beyond this stated combination as well in further embodiments.

When a robotic or automated basket movement system such as a robotic arm or an automated gantry system is used, the fryer controller 24 can also or alternatively provide signals for all of these statuses (i.e., statuses that would be displayed on one or more visual indicators 30) directly to the automated basket movement system, such that new baskets 14 are added in the most optimal sequence at the available cooking vats 18 of the fryer 10. Likewise, signals are provided to cause the automated basket movement system to promptly retrieve baskets 14 when a cooking cycle is completed, while avoiding basket movements to any cooking vats 18 currently inactive due to filtration or the like.

With continued reference to FIG. 4, thus, when putting all of the added equipment together from these embodiments with operational links via the controller 24, a more automated and desirable operation of the fryer 10 is enabled. The status of any single cooking vat 18 (e.g., cooking, ready for cook, not available, ideal for next basket placement) is continuously communicated via one or more visual indicators 30 of the visual indicator system 28 to an operator of the fryer 10. The movement devices 12 ensure consistent quality of food product 20 (of various types) by visually identifying the type of food product 20 using the cameras 26 and image processor 70 of the vision system 22 and then actuating movements of the basket 14 into and out of the cooking medium 16 and actuating shaking movements tailored to the specific ideal cooking cycle for that type of food product 20. Food product 20 is thus not overcooked, undercooked, or subjected to undesirable clumping or product marriages during cooking cycles.

Moreover, when cooking medium 16 level or quality indicates a filtration, refilling, or replacement is necessary (which can be caused by a number of cooking cycles completed since last filtration as well as the coloration detected with this vision-based control), the controller 24, as prompted by inputs from the camera(s) 26 and image processor 70, initiates and performs filtration, refilling, and/or changing out of the cooking medium 16 at the particular cooking vat 18, while also avoiding placement of new baskets 14 of food product 20 at that cooking vat 18 until the filtration cycle process is completed. The fryer controller 24 can also plan for filtration, refilling, or replacement cycles to be performed at convenient times when demand is not so high and a cooking vat 18 is not needed for cooking operations for the requisite time period (e.g., 4-5 minutes) needed for a normal filtration, refilling, or replacement cycle. Thus, cooking medium 16 quality and level is improved as compared to conventional designs relying on human operator intervention to manage such parameters.

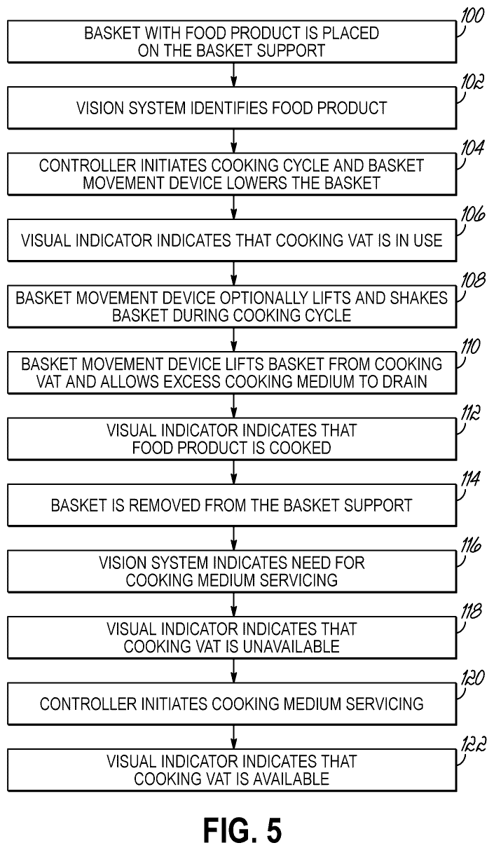

Referring now to FIG. 5, a series of exemplary operational steps taken by the fryer 10 of the embodiments of this invention and/or operator of the fryer 10 are shown in the schematic flowchart of FIG. 5. It will be understood that more or fewer operational steps may be performed, as these are just some of the operations enabled with more automation by the embodiments described herein. At step 100, a basket 14 containing fresh or frozen food product 20 to be cooked is placed on the basket support 44 of the movement device 12 at a particular cooking vat 18. This placement of the basket 14 may be done by a human operator and guided by visual indicators 30 of the next vat 18 to use by the visual indicator system 28 (as described in greater detail below), or it may be done by a robot (e.g., a robotic arm or gantry) moving the basket 14 and communicating with the fryer controller 24 to know which cooking vat 18 to use next. At step 102, the vision system 22 detects the type of food product 20 in the basket 14 such as by capturing images of the food product 20 with the camera 26 and using the integrated image processor 70 to correctly identify what the food product 20 type is. This identification of the food product 20 in the basket 14 is communicated as an input to the fryer controller 24, which then outputs control signals to the movement device 12 in accordance with temperatures, timers, and time periods for the cooking cycle of that particular food product 20.

At step 104, the movement device 12 is actuated by the fryer controller 24 to lower the basket 14 and submerge the food product 20 and the basket 14 in the cooking medium 16 thus beginning the cooking cycle of the food product 20. At this time, as shown in step 106, the visual indicator 30 located above the vat 18 in which the food product 20 is being cooked may communicate (e.g., to an operator) that the cooking vat 18 is in use. Such may be accomplished by illuminating the visual indicator 30 (e.g., one or more LED lights 72) associated with the cooking vat 18 in a particular color, combination, or pattern understood to mean that the cooking vat 18 is currently in use.

With continued reference to FIG. 5, at step 108, at a midpoint or other desirable designated time during the cooking cycle, the fryer controller 24 may also cause the movement device 12 to (optionally) lift and shake the basket 14 with rapid oscillation/vibration movements to break up any clumps or product marriages that developed during the cooking process. A particular cooking cycle could call for no shaking or one or more shakes of the basket 14 during the cooking cycle. Such would depend on the particular food product 20 as identified by the vision system 22 and as understood by the controller 24. At step 110, the movement device 12 is actuated by the fryer controller 24 to raise the basket 14 out of the cooking medium 16 and allow for a drip time such that excess cooking medium 16 can fall off (i.e., drip from) the cooked food product 20 in the basket 14. At step 112, after the cooking cycle is complete and adequate drip time has passed, the movement device 12 may unlock the retention clip 46 and signal (via the visual indicators 30 or by sending a control signal to a robotic arm or gantry) that the basket 14 is ready for removal. At step 114, the basket 14 may be removed from the support 44 by a human operator, robotic arm, or gantry, for example.

At the same time as all of these operations, the fryer controller 24 is detecting incoming/upcoming cooking demands and is preferably planning the workflow of the fryer 10 to most optimally handle all demands. As a part of this workflow management, at step 116, the vision system 22 communicates signals to the fryer controller 24 when the cooking medium 16 (e.g., oil) level or quality (as can be visually detected by camera(s) 26 and image processor 70 based on coloration or relative level of the cooking medium 16 in the cooking vat 18) is determined to require a filtration cycle or other service, such as refilling (e.g., top off) or replacement. Alternatively, the fryer controller 24 may also queue up a next filtration, refilling, or replacement based on how many vats 18 are currently in use and the number of cooking cycles for a vat 18 since the most recent filtration, refilling service, or replacement was performed. At step 118, while the cooking vat 18 is undergoing service, the visual indicator system 28 may communicate to an operator of the fryer 10 that the particular cooking vat 18 is unavailable for use and undergoing maintenance. For example, the visual indicator 30 (e.g., one or more LED lights 72) associated with the cooking vat 18 may illuminate in a particular color, combination, or pattern understood to mean that the cooking vat 18 is unavailable for use. In any event, at step 120, the fryer controller 24 activates the recirculation and filtration system of the fryer 10 to automatically perform filtration and replacement of the cooking medium 16 for a cooking vat 18 that is not actively in use.

With continued reference to FIG. 5, at step 122, after the maintenance operation (e.g., filtration, refilling, replacement) is completed, the fryer controller 24 uses the visual indicator system 28 to communicate to an operator of the fryer 10 that the particular cooking vat 18 is once again available for use and ready to receive a new basket 14 of food product 20. For example, the visual indicator 30 (e.g., one or more LED lights 72) associated with the cooking vat 18 may illuminate in a particular color, combination, or pattern understood to mean that the cooking vat 18 is ready to receive a new basket 14 of food product 20. As with prior steps, the visual indicator 30 can be replaced by a direct control signal to a basket movement robot (e.g., robotic arm or gantry arm) when those are used at the fryer 10. As will be understood from these operational steps in FIG. 5, the fryer controller 24 interacting with the new equipment at the fryer 10 automates much of the cooking and cooking medium 16 management steps so that high quality is maintained with less operator input required.

In general, the routines executed to implement the embodiments of the invention, whether implemented as part of an operating system or a specific application, component, program, object, module or sequence of instructions, or a subset thereof, may be referred to herein as “computer program code,” or simply “program code.” Program code typically comprises computer-readable instructions that are resident at various times in various memory and storage devices in a computer and that, when read and executed by one or more processors in a computer, cause that computer to perform the operations necessary to execute operations or elements embodying the various aspects of the embodiments of the invention. Computer-readable program instructions for carrying out operations of the embodiments of the invention may be, for example, assembly language, source code, or object code written in any combination of one or more programming languages.

Various program code described herein may be identified based upon the application within which it is implemented in specific embodiments of the invention. However, it should be appreciated that any particular program nomenclature which follows is used merely for convenience, and thus the invention should not be limited to use solely in any specific application identified or implied by such nomenclature. Furthermore, given the generally endless number of manners in which computer programs may be organized into routines, procedures, methods, modules, objects, and the like, as well as the various manners in which program functionality may be allocated among various software layers that are resident within a typical computer (e.g., operating systems, libraries, API's, applications, applets, etc.), it should be appreciated that the embodiments of the invention are not limited to the specific organization and allocation of program functionality described herein.

The program code embodied in any of the applications/modules described herein is capable of being individually or collectively distributed as a computer program product in a variety of different forms. In particular, the program code may be distributed using a computer-readable storage medium having computer-readable program instructions thereon for causing a processor to carry out aspects of the embodiments of the invention.

Computer-readable storage media, which is inherently non-transitory, may include volatile and non-volatile, and removable and non-removable tangible media implemented in any method or technology for storage of data, such as computer-readable instructions, data structures, program modules, or other data. Computer-readable storage media may further include RAM, ROM, erasable programmable read-only memory (EPROM), electrically erasable programmable read-only memory (EEPROM), flash memory or other solid state memory technology, portable compact disc read-only memory (CD-ROM), or other optical storage, magnetic cassettes, magnetic tape, magnetic disk storage or other magnetic storage devices, or any other medium that can be used to store data and which can be read by a computer. A computer-readable storage medium should not be construed as transitory signals per se (e.g., radio waves or other propagating electromagnetic waves, electromagnetic waves propagating through a transmission media such as a waveguide, or electrical signals transmitted through a wire). Computer-readable program instructions may be downloaded to a computer, another type of programmable data processing apparatus, or another device from a computer-readable storage medium or to an external computer or external storage device via a network.

Computer-readable program instructions stored in a computer-readable medium may be used to direct a computer, other types of programmable data processing apparatuses, or other devices to function in a particular manner, such that the instructions stored in the computer-readable medium produce an article of manufacture including instructions that implement the functions, acts, or operations specified in the flowcharts, sequence diagrams, or block diagrams. The computer program instructions may be provided to one or more processors of a general purpose computer, a special purpose computer, or other programmable data processing apparatus to produce a machine, such that the instructions, which execute via the one or more processors, cause a series of computations to be performed to implement the functions, acts, or operations specified in the flowcharts, sequence diagrams, or block diagrams.

The flowcharts and block diagrams depicted in the figures illustrate the architecture, functionality, or operation of possible implementations of systems, methods, or computer program products according to various embodiments of the invention. In this regard, each block in the flowchart or block diagrams may represent a module, segment, or portion of instructions, which comprises one or more executable instructions for implementing the specified logical function or functions.

In certain alternative embodiments, the functions, acts, or operations specified in the flowcharts, sequence diagrams, or block diagrams may be re-ordered, processed serially, or processed concurrently consistent with embodiments of the invention. Moreover, any of the flowcharts, sequence diagrams, or block diagrams may include more or fewer blocks than those illustrated consistent with embodiments of the invention. It should also be understood that each block of the block diagrams or flowcharts, or any combination of blocks in the block diagrams or flowcharts, may be implemented by a special purpose hardware-based system configured to perform the specified functions or acts, or carried out by a combination of special purpose hardware and computer instructions.

The automatic basket movement device 12, vision system 22 including one or more cameras 26 and image processor 70, and visual indicator system 28 including one or more visual indicators 30 (e.g., one or more LED lights 72 in a housing 74) of the embodiments of this invention improve the field of cooking devices such as fryers 10. To this end, less human operator interaction is needed to achieve consistent high quality of cooked food product 20 (e.g., fried products without clumps/product marriages of food stuck together following the cooking cycle and without overcooking or undercooking) as conventional fully manual methods used with fryers. Moreover, the integration of the shaking movement or functionality into the same drive as the primary movement all caused by movement device 12 reduces manufacturing cost and complexity of the fryer 10, while also reducing the number of components that may be subject to failure and/or need regular maintenance. Automation of various tasks associated with cooking cycles and filtration cycles and/or cooking medium 16 management eliminates opportunities for operator error or in optimal timing of actions taken at or by the fryer 10. The net result is more consistent cooked food product 20 from the fryer 10 with less labor demand. Therefore, the fryer 10 and operations described herein are cost-effective and functionally improved from fryers and cooking methods of known designs. These concepts can be modified and tailored to many different types of fryers as well as the added equipment is designed as a retrofit applicable to almost any known fryer, thereby allowing for improvements in restaurants of many different designs.

While the present invention has been illustrated by the description of one or more embodiments thereof, and while the embodiments have been described in considerable detail, they are not intended to restrict or in any way limit the scope of the appended claims to such detail. The various features shown and described herein may be used alone or in any combination. Additional advantages and modifications will readily appear to those skilled in the art. The invention in its broader aspects is therefore not limited to the specific details, representative apparatus and methods and illustrative examples shown and described. Accordingly, departures may be made from such details without departing from the scope or spirit of Applicants' general inventive concept.

### Alternative Aspects of the Invention

In an alternative aspect of the invention, a method for managing basket workflow at an automated cooking system is disclosed. The automated cooking system includes a fryer including at least one fryer vat. The at least one fryer vat includes a basket movement device for receiving and moving a basket located proximate to the at least one fryer vat. The automated cooking system also includes a vision system including at least one camera and at least one image processor. The automated cooking system also includes a visual indicator system including at least one visual indicator to visually communicate information to an operator. The method includes illuminating the at least one visual indicator to communicate to the operator that the at least one fryer vat should receive the next basket. The method further includes placing the basket containing a food product on the basket movement device. The method further includes identifying, by the at least one camera and the at least one image processor, the food product in the basket. The method further includes determining and initiating, by a fryer controller, the cooking cycle for the identified food product. The method further includes illuminating the at least one visual indicator to communicate to the operator that the food product in the basket is fully cooked and that the basket is ready to be removed from the fryer. The method further includes removing the basket containing fully cooked food product from the basket movement device.

In one embodiment, the method may further include determining, by a fryer controller, that the identified food product requires shaking and shaking, by the basket support, the at least one basket during the cooking cycle with rapid oscillation and/or vibration movements to break up any clumps or product marriages of the food product in the basket. The method may further include, after the food product is fully cooked, suspending the basket above a cooking medium for a predetermined period of time to allow excess cooking medium to drip from the food product and illuminating the at least one visual indicator to communicate to the operator that the food product in the basket is fully cooked, but that the basket is not ready to be removed from the fryer.

In one embodiment, the method may further include illuminating the at least one visual indicator to communicate to the operator that an associated fryer vat is unavailable to be used. The fryer vat may be unavailable because the fryer vat is being used to cook food product. Alternatively, the fryer vat may be unavailable because the fryer vat is undergoing a maintenance operation. The maintenance operation may be filtering of a cooking medium. Alternatively, the maintenance operation may be refilling or changing out of a cooking medium. The method may further include placing the basket containing a food product on a basket movement device of an alternative fryer vat. The alternative fryer vat may be different than the unavailable fryer vat.

In a further alternative aspect of the invention, a method for managing basket workflow at an automated cooking system is provided. The automated cooking system includes a fryer including at least one fryer vat. The at least one fryer vat includes a basket movement device for receiving and moving a basket located proximate to the at least one fryer vat. The automated cooking system also includes a vision system including at least one camera and at least one image processor. The automated cooking system also includes a visual indicator system including at least one visual indicator to visually communicate information to an operator. The method includes detecting, by the at least one camera and the at least one image processor, that a maintenance operation is required in the at least one fryer vat. The method further includes illuminating the at least one visual indicator to communicate to the operator that the at least one fryer vat is unavailable to be used due to the maintenance operation. The method further includes initiating, by a fryer controller, the maintenance operation. The method further includes illuminating the at least one visual indicator to communicate to the operator that the at least one fryer vat is available to be used after completion of the maintenance operation.

In one embodiment, the method may further include placing the basket containing a food product on a basket movement device of an alternative fryer vat. The alternative fryer vat may be different than the unavailable fryer vat. The maintenance operation may be filtration of a cooking medium in the at least one fryer vat, and the method may further include identifying, by the at least one camera and the at least one image processor, a color of the cooking medium within the at least one fryer vat and examining, by the fryer controller, the color of the cooking medium to determine if the cooking medium requires filtration. Alternatively, the maintenance operation may be refilling or replacement of a cooking medium in the at least one fryer vat, and the method may further include identifying, by the at least one camera and the at least one image processor, a surface level of the cooking medium within the at least one fryer vat and examining, by the fryer controller, the surface level of the cooking medium to determine if the at least one fryer vat requires refilling or replacement of the cooking medium.

In one embodiment, the method may further include scheduling, by the fryer controller, the maintenance operation for a time in the future. The maintenance operation may be scheduled for the time when demand for food product output of the fryer is low. Alternatively, the maintenance operation may be scheduled for the time when less than all of the fryer vats at the fryer will be in use. Alternatively, the maintenance operation may be scheduled for a predetermined time measured from a time of the last maintenance operation.

What is claimed is:

1. An automated cooking system comprising:
a fryer including at least one fryer vat configured to hold a cooking medium;
at least one basket configured to receive and hold a food product for cooking in the cooking medium at the fryer; and
a basket movement device located proximate to the at least one fryer vat, the basket movement device including a basket support for engaging the at least one basket, the basket movement device configured to move the at least one basket into and out of the cooking medium,
wherein the basket movement device includes a retention clip to releasably secure the at least one basket to the basket support.

2. The automated cooking system of claim 1, wherein the retention clip engages at least a portion of the basket, and wherein the retention clip is biased to lock the at least one basket in position on the basket support thereby preventing the at least one basket from being inadvertently removed from the basket support.

3. The automated cooking system of claim 2, wherein the bias is applied by a torsion spring of the basket support.

4. The automated cooking system of claim 2, wherein the retention clip is disengaged by contact with a cam catch surface, wherein contact with the cam catch surface causes the retention clip to pivot against the bias such that the at least one basket may be removed from the basket support.

5. The automated cooking system of claim 2, wherein the retention clip is disengaged by a pneumatic cylinder, wherein the pneumatic cylinder causes the retention clip to pivot against the bias such that the at least one basket may be removed from the basket support.

6. The automated cooking system of claim 1, wherein the automated cooking system further comprises a vision system, the vision system including at least one camera and at least one image processor.

7. The automated cooking system of claim 6, wherein the at least one camera is mounted on a support, the support shared with the basket movement device.

8. The automated cooking system of claim 6, wherein the at least one camera is configured to capture at least one visual image of the food product within the at least one basket, and wherein the at least one image processor is configured to identify the food product from the at least one visual image.

9. The automated cooking system of claim 6, wherein the at least one camera is configured to capture at least one visual image of a color and/or a level of the cooking medium in the at least one fryer vat, and wherein the at least one image processor is configured to identify a change in the color and/or the level of the cooking medium.

10. The automated cooking system of claim 1, wherein the automated cooking system further comprises a visual indicator system, the visual indicator system including at least one visual indicator to visually communicate information to an operator.

11. The automated cooking system of claim 10, wherein the at least visual indicator is mounted on a support, the support shared with the basket movement device.

12. The automated cooking system of claim 10, wherein the at least one visual indicator illuminates in a color or in a combination/pattern to communicate that an associated fryer vat should next receive at the at least one basket.

13. The automated cooking system of claim 10, wherein the at least one visual indicator illuminates in a color or in a combination/pattern to communicate that the food product in the at least one basket of an associated fryer vat is fully cooked and that the at least one basket is ready to be removed from the fryer.

14. The automated cooking system of claim 7, further comprising:
a visual indicator system, the visual indicator system including at least one visual indicator configured to illuminate with different colors or different combinations of lights and/or colors to visually communicate information to an operator,
wherein the at least one series of lights is mounted on the support shared with the basket movement device and shared with the at least one camera.

15. A method of cooking food products with an automated cooking system, the method comprising:
providing the automated cooking system comprising:
a fryer including at least one fryer vat configured to hold a cooking medium; and
a basket movement device located proximate to the at least one fryer vat, the basket movement device including a basket support;
attaching at least one basket of food product to the basket support;
releasably securing the at least one basket to the basket support with a retention clip, wherein the retention clip is biased to lock the at least one basket in position on the basket support thereby preventing the at least one basket from being inadvertently removed from the basket support;
moving the at least one basket downwardly, by the basket movement device, to a lower position in which the at least one basket is substantially submerged in the cooking medium held within the at least one fryer vat, thereby beginning a cooking cycle for the food product; and
moving the basket upwardly, by the basket movement device, to an upper position in which the at least one basket is located above the cooking medium in the at least one fryer vat, when the cooking cycle is completed.

16. The method of cooking food products of claim 15, wherein the retention clip includes a torsion spring, and wherein the step of releasably securing the at least one basket further comprises:
applying a spring bias by the torsion spring to lock the at least one basket in position on the basket support.

17. The method of cooking food products of claim 16, wherein the method further comprises:
disengaging the retention clip by contacting the retention clip with a cam catch surface to cause the retention clip to pivot against the spring bias of the torsion spring.

18. The method of cooking food products of claim 16, wherein the method further comprises:
disengaging the retention clip using a pneumatic cylinder to cause the retention clip to pivot against the spring bias of the torsion spring.

19. The method of cooking food products of claim 15, wherein the automated cooking system further comprises a vision system, the vision system including at least one camera and at least one image processor, and wherein the method further comprises:
capturing, by the at least one camera, at least one visual image of the food product within the at least one basket;
identifying, by the at least one image processor, the food product from the at least one visual image;
determining, by a fryer controller, the cooking cycle for the identified food product; and
initiating, by the fryer controller, the cooking cycle.

20. The method of cooking food products of claim 19, wherein the method further comprises:
determining, by a fryer controller, that the identified food product requires shaking; and
shaking, by the basket support, the at least one basket during the cooking cycle with rapid oscillation and/or vibration movements to break up any clumps or product marriages of the food product in the basket.

21. The method of cooking food products of claim 20, wherein the step of shaking further comprises:
moving the basket upwardly during the cooking cycle prior to shaking, by the basket movement device, to an upper position in which the basket is located above the cooking medium in the fryer vat, thereby pausing the cooking cycle for the food product; and
moving the at least one basket downwardly during the cooking cycle after shaking, by the basket movement device, to a lower position in which the at least one basket is substantially submerged in the cooking medium held within the fryer vat, thereby resuming the cooking cycle for the food product.

22. The method of cooking food products of claim 15, wherein the automated cooking system further comprises a vision system, the vision system including at least one camera and at least one image processor, and wherein the method further comprises:
capturing, by the at least one camera, at least one visual image of a color of the cooking medium in the at least one fryer vat;
identifying, by the at least one image processor, a change in the color of the cooking medium from the at least one visual image;
determining, by a fryer controller, that the cooking medium requires filtration; and
initiating, by the fryer controller, filtration of the cooking medium.

23. The method of cooking food products of claim 15, wherein the automated cooking system further comprises a vision system, the vision system including at least one camera and at least one image processor, and wherein the method further comprises:
capturing, by the at least one camera, at least one visual image of a level of the cooking medium in the at least one fryer vat;
identifying, by the at least one image processor, a change in the level of the cooking medium from the at least one visual image;
determining, by a fryer controller, that the cooking medium requires refilling; and
initiating, by the fryer controller, refilling of the cooking medium.

24. The method of cooking food products of claim 15, wherein the automated cooking system further comprises a vision system, the vision system including at least one camera and at least one image processor, and wherein the method further comprises:
capturing, by the at least one camera, at least one visual image of a level of the cooking medium in the at least one fryer vat;
identifying, by the at least one image processor, a change in the level or a change in the color of the cooking medium from the at least one visual image;
determining, by a fryer controller, that the cooking medium requires replacement; and
initiating, by the fryer controller, replacement of the cooking medium.

25. The method of cooking food products of claim 15, wherein the automated cooking system further comprises a vision system, the vision system including at least one camera and at least one image processor, and wherein the method further comprises:
capturing, by the at least one camera, at least one visual image of the at least one fryer vat;
identifying, by the at least one image processor, a status of the at least one fryer vat;
interpreting, by a fryer controller, the status of the at least one fryer vat; and
communicating, by a visual indicator system, the status of the at least one fryer vat to an operator.

26. The method of cooking food products of claim 15, wherein the automated cooking system further comprises a visual indicator system, the visual indicator system including at least one visual indicator, and wherein the method further comprises:
illuminating the at least one visual indicator in a color and/or in a combination/pattern to communicate information to an operator regarding cooking status or actions needed at one or more of the fryer vats.

27. The method of cooking food products of claim 26, wherein the step of illuminating the at least one visual indicator further comprises each of the following:
illuminating the at least one visual indicator in a color and/or in a combination/pattern to communicate to the operator that an associated fryer vat should next receive the at least one basket;
illuminating the at least one visual indicator in in a color and/or in a combination/pattern to communicate to the operator that the food product in the at least one basket of an associated fryer vat is in the process of being cooked;
illuminating the at least one visual indicator in a color and/or in a combination/pattern to communicate to the operator that the food product in the at least one basket of an associated fryer vat is fully cooked and that the at least one basket is ready to be removed from the fryer; and
illuminating the at least one visual indicator in a color and/or in a combination/pattern to communicate to the operator that an associated fryer vat is unavailable to be used.

28. A method for managing basket workflow at an automated cooking system, which includes a fryer including at least one fryer vat including a basket movement device for receiving and moving a basket located proximate to the at least one fryer vat, a vision system including at least one camera and at least one image processor, and a visual indicator system including at least one visual indicator to visually communicate information to an operator, the method comprising:
illuminating the at least one visual indicator to communicate to the operator that the at least one fryer vat should receive the next basket;
placing the basket containing a food product on the basket movement device;
identifying, by the at least one camera and the at least one image processor, the food product in the basket;
determining and initiating, by a fryer controller, the cooking cycle for the identified food product;
illuminating the at least one visual indicator to communicate to the operator that the food product in the basket is fully cooked and that the basket is ready to be removed from the fryer; and
removing the basket containing fully cooked food product from the basket movement device.
